(19) United States
(12) Patent Application Publication
(10) Pub. No.: US 2004/0195152 A1
(43) Pub. Date: Oct. 7, 2004

(54) Method for the removal and recovery of the oily component from drill cuttings

(75) Inventors: Felicia Massetti, Castelnuovo Di Porto (IT); Alessandro Nardella, Rome (IT); Raffaele Tomaciello, Mentana (IT); Paolo Pallado, Padova (IT); Alberto Guarneri, Casalbuttano (IT)

Correspondence Address: OBLON, SPIVAK, MCCLELLAND, MAIER & NEUSTADT, P.C., 1940 DUKE STREET, ALEXANDRIA, VA, 22314, US

(73) Assignees: ENI S.p.A., Rome (IT); ENITECNOLOGIE S.p.A., Milan (IT)

(21) Appl. No.: 10/736,737

(22) Filed: Dec. 17, 2003

(30) Foreign Application Priority Data
Dec. 20, 2002 (IT) MI2002A 002707

(51) Int. Cl. C23G 1/36; B08B 7/04

(52) U.S. Cl. 209/11; 175/66; 134/10

(57) ABSTRACT

Method for the removal and recovery of the oily component from cuttings coming from the drilling of oil wells by treatment of the cuttings with a solvent, which can be compressed to the liquid state, at a pressure value ranging from 45 to 80 bar and a temperature corresponding to the saturation value.

The present invention relates to a method for the treatment of oily drill cuttings.

More specifically, the present invention relates to a method for the removal and recovery of the oily component from drill cuttings which allows the contemporaneous de-classification of the cutting from dangerous waste-products.

The term “drill cuttings”, as used in the present description and claims, indicates the crushed material produced during the drilling mixed with drilling sludge. This is therefore a fluid with a rheology typical of aqueous suspensions with a high solid content such as sludge or slurry.

It is known that the function of drilling sludge is to consolidate the walls of the hole of an oil well, protect the metallic parts from corrosion, cool and lubricate the bit during drilling. Sludge, which can be water-based or oil-based, also supplies the pressure for keeping the geological formation integral and has the function of carrying the cuttings produced in the excavation by the action of the bit, to the surface.

Oil sludge consists, for example, of mineral oil, barite, bentonite and other additives such as emulsifying agents and polymers.

In the past drill cuttings, mostly coming from off-shore platforms, were discharged into the sea creating an unacceptable environmental impact level. There are also considerable problems with respect to dispersion on the ground.

Various methods are used for removing oil sludge from cuttings: among these, washing systems with detergents, thermal and distillation systems. The main disadvantages of these methods are respectively linked to low efficiency, limited safety especially when operating off-shore, high costs and plant construction complexity.

The use of a compressible solvent for the recovery of oil from drill cuttings, with acceptable residual concentration levels in the solid, was proposed with reference to “supercritical processes” i.e. bringing the fluid above its critical conditions during the treatment of the cutting. The application, described in S. Saintpére et al. (2000), “Supercritical CO₂ extraction applied to oily drilling cuttings”, SPE 63126, SPE International, using carbon dioxide (CO₂), is not competitive from an economical point of view.

It was also verified that the treatment process effected with CO₂ under supercritical conditions is strongly conditioned by the physico-chemical characteristics of the cutting which jeopardizes the removal efficacy, in terms of oil recovery and residual concentration in the solid.

The Applicant has now found that the oily part of cuttings coming from the drilling of oil wells can be removed with an extraction method which uses, as solvent, a fluid compressible to the liquid state, obtaining an oil with the same characteristics as the mud formulation product and which, when suitable additives are added, can be re-used in other drillings whereas the solid part (cuttings) can be re-admitted into the environment or sent for conventional disposal.

With respect to the compressible fluid brought to so-called “supercritical” conditions, or beyond the critical point, the use of the compressible solvent in liquid phase has the following advantages:

recovery efficiency of the oil comparable with that obtained with fluid in the supercritical state, with the exception of CO₂, operating however at lower pressure and temperatures;

lower dehydration of the solid phase and therefore lower production of water to be sent for treatment;

decrease in the plant costs, due to the limited operating pressures, in terms of equipment and piping.

Furthermore, by adopting the functioning scheme indicated below as thermo-compression process, the energy consumptions are greatly reduced, thus allowing the treatment costs to be reduced to competitive levels with consolidated technologies.

In addition, the oily fraction removed with the use of the compressible fluid is completely recovered at the end of the process without being contaminated by processing solvents and can be used again for subsequent processings, following refining processes and/or the addition of suitable additives. Finally, the preliminary treatment of the solid charge, effected through a mixing with inert material, allows the process restrictions which limit its feasibility, to be overcome.

The use as solvent of a fluid compatible with problems associated with pollution, is in line with the growing demand for environmental protection, as a result of the nondangerous nature of the fluid and also because of the absolute lack of contaminating waste-products deriving from the process.

The limits of use of said solvents can be overcome by exploiting the physico-chemical characteristics of the solvent so that it passes from a thermodynamic to a thermo-compression cycle, characterized by moderate operating pressures and low energy requirements.

In accordance with this, the objective of the present invention relates to a method for the decontamination of oily cuttings, coming from the drilling of oil wells, and the contemporaneous recovery of the oily component, comprising the following steps:

a) optional mixing of the cuttings with 10-40% by weight with respect to the total of an inert material, preferably consisting of the cutting already treated and therefore partially recycled;

b) treatment of said cuttings with a solvent compressible to the liquid state at a pressure value ranging from 45 to 80 bar and a temperature corresponding to the saturation value; the operation takes place by continuously feeding the solvent in liquid phase to the vessel containing the cuttings, in a ratio from 2 to 20 times by weight with respect to the cuttings;

c) separation of the liquid phase (solution) from the solid phase; the solid phase remains confined inside the treatment vessel;

d) expansion of the solution leaving step (c), separation of the oily phase and recycling of the solvent in vapour phase; the oily phase is discharged and recovered from the expansion vessel;

e) compression and cooling of the solvent vapour and its recycling to step (a), after possible under-cooling.

More specifically, the present invention is illustrated in the enclosed claims.

The method according to the present invention has considerable advantages both from an economical and environmental point of view. The drill cuttings, defined by current regulations as being harmful waste-products, have such characteristics as to make them, after treatment, compatible with the environment, whereas the oily part removed can be re-used as drilling sludge, with the addition of possible additives.

The solvent used is inert under the process and environmental conditions. The process operates with a closed cycle, with complete recycling of the solvent.

In the thermo-compression cycle, a compressor is used for compressing the solvent in vapour-gas state, and the phase passages of the process fluid take place by mutual energy exchange in the sense that the vaporization and condensation heat is reciprocally exchanged.

The method, object of the present invention, involves the use of small dimensional machines and consequently with the possibility of use also for off-shore applications. From an economical point of view, moreover, the present method seems to be of great interest with respect to alternative on-shore processes.

Some applicative examples are provided hereunder for purely illustrative purposes, referring to the removal of the oily fraction from a cutting following two distinct processes: the thermo-compression cycle and the “classical” cycle.

### EXAMPLE 1

### Thermo-Compression Cycle

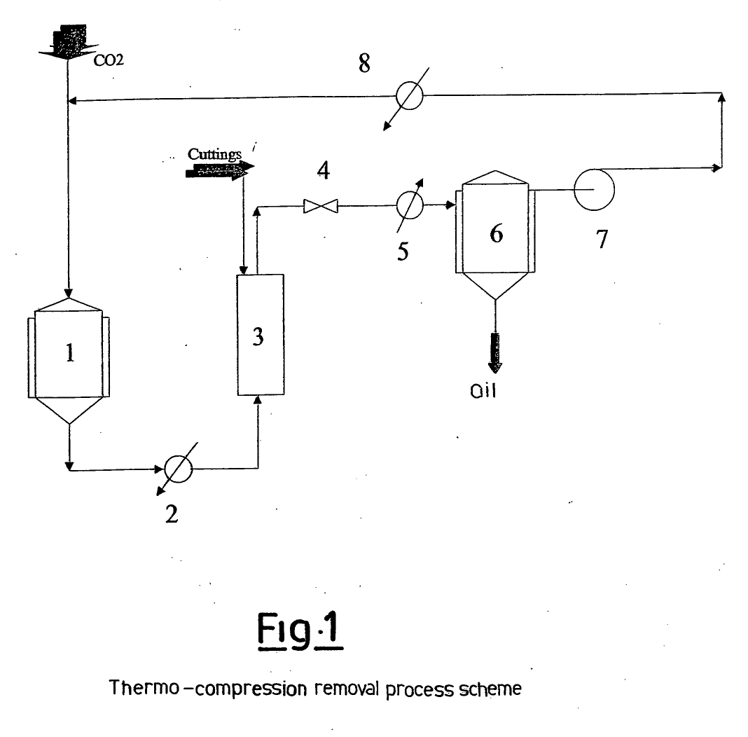

A typical embodiment of the method, object of the present invention, is schematized in the block scheme illustrated in FIG. 1, with reference to the thermo-compression process.

The cutting to be treated is closely mixed with a certain quantity of inert material, in a percentage varying from 10 to 40% w/w, generally 20% w/w.

The resulting mass is subsequently charged into a pressure vessel, said extractor (3) being according to the known art. The extractor is equipped with filtrating septa up- and down-stream, generally made of porous steel, for holding the cutting.

After closing, the extractor it is pressurized with the solvent in vapour phase, taken from the accumulation tank (1). The pressurization can be effected from the inlet situated at the bottom of the vessel or from the inlet situated at the head, generally from the bottom.

When a pressure value is reached, which is close to that of the accumulation tank, the vapour feeding is interrupted and the extractor is fed with the solvent in liquid phase, still from the accumulation tank. The pressurization can be effected from the inlet situated at the bottom of the vessel or from the inlet situated at the head, generally from the bottom.

The complete filling of the reactor is obtained by acting on the volumetric compressor (7) situated downstream of the extractor, by sucking the vapour from the extractor and forcing the liquid from the accumulation tank.

The liquid is closely distributed in the cutting, dissolving the oily fraction.

The whole plant is pressurized following an analogous procedure, in all parts. The removal phase, begins by continuously feeding the liquid to the extractor, using a pumping system, not illustrated, with the extractor situated in line with respect to the solvent flow.

The liquid solution leaving the extractor, consisting of the solvent and the dissolved oily fraction, flows through the lamination valve (4) undergoing decompression at a lower pressure value. The oily fraction is thus continuously removed from the cutting.

The liquid-vapour mixture which is formed following lamination, is sent to a heat exchanger (5) which has the function of bringing the solvent forming the mixture to vapour phase, whereas the oily fraction is separated from the stream as liquid phase.

The mixture of vapour solvent-liquid oily phase is passed through a separator with a cyclone effect (6), or a series of several separators with a gravimetric and cyclone effect, to obtain the complete separation of the liquid oily fraction from the solvent vapour stream.

An optional additional separation filter can complete the configuration of the separation section.

The liquid oily fraction is collected at the bottom of the separator or separators, from which it is removed by an intermittent vent through the valve situated at the bottom of each separator.

The solvent in aeriform vapour-gas phase leaving the separation section is cooled and condensed (8), and recovered in the accumulation tank (1), from where it is sent, after under-cooling (2), for re-use in the extraction cycle.

With reference to the thermo-compression cycle, the moving of the solvent takes place by means of a volumetric compressor (7) which sucks the vapour leaving the separation section (6) and compresses it at the pressure value of the accumulation tank.

The removal phase is prolonged until the required recovery parameter is reached, referring to the percentage of oily fraction removed with respect to its initial content in the cutting (removal percentage), or the percentage of oily fraction removed referring to the quantity of raw cutting treated (yield percentage).

The time parameter of the removal process is provided by the ratio between the quantity of solvent used with respect to the weight unit of cutting treated. This weight ratio depends on the process parameters, the type of solvent used, and the type of cutting treated, and ranges from 2 to 30, generally 8.

When the removal phase has been interrupted by the stoppage of the continuous flow of solvent, the extractor is isolated and the solvent contained therein is recovered using the process compressor or an auxiliary compressor. The solvent is recovered in the accumulation tank.

The recovery phase of the solvent is followed by the final depressurization phase to the atmospheric value and subsequently the recovery of the cutting treated, following known procedures.

The data referring to a test carried out according to the procedure described above are as follows:

| Solvent fluid | carbon dioxide (CO₂) |
|---|---|
| Type of cutting | conventional |
| Content of inert product | 25% |
| Initial oil content | 9.5% |
| Extraction pressure | 64 bar |
| Extraction temperature | 20° C. |
| Ratio between CO₂ referring to the cutting | 6 kg/kg |
| Final oil content | 0.8% |
| Oil removal degree | >90% |

### EXAMPLE 2

### Classical Cycle

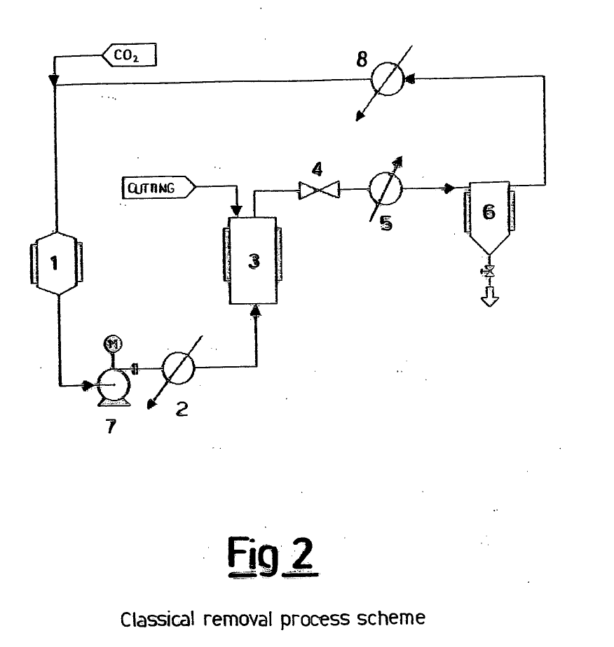

A typical embodiment of the method, object of the present invention, according to the classical process, is schematized in the block scheme illustrated in FIG. 2.

The cutting to be treated is closely mixed with a certain quantity of inert material, in a percentage varying from 10 to 40% w/w, generally 20% w/w.

The resulting mass is subsequently charged into the extractor (3), according to the known art.

The extractor is analogous to that used in the thermo-compression cycle.

After closing, the extractor is pressurized with the solvent in vapour phase, taken from the accumulation tank (1), as in the previous example.

When a pressure value is reached, which is close to that of the accumulation tank value, the vapour feeding is interrupted and the extractor is fed with the solvent in liquid phase, still from the accumulation tank. Also in this case, the complete filling of the extractor is obtained by acting on the volumetric pump situated upstream of the extractor, by sucking the liquid from the accumulation tank.

The liquid is closely distributed in the cutting, dissolving the oily fraction.

The whole plant is pressurized following an analogous procedure, in all parts. The removal phase begins by continuously feeding the liquid to the extractor using a pumping system, not illustrated, with the extractor situated in line with respect to the solvent flow.

The liquid solution leaving the extractor, consisting of the solvent and the dissolved oily fraction, flows through the lamination valve (4) undergoing decompression at a lower pressure value. The oily fraction is thus continuously removed from the cutting.

The liquid-vapour mixture which is formed following lamination, is sent to a heat exchanger (5) which has the function of bringing the solvent forming the mixture to vapour phase, whereas the oily fraction is separated from the stream as liquid phase.

The mixture of vapour solvent-liquid oily phase is passed through a separator with a cyclone effect (6), or a series of several separators with a gravimetric and cyclone effect, to obtain the complete separation of the liquid oily fraction from the solvent vapour stream.

An additional separation filter can complete the configuration of the separation section.

The liquid oily fraction is collected at the bottom of the separator or separators, from which it is removed by an intermittent vent through the valve situated at the bottom of each separator.

The solvent in aeriform vapour-gas phase leaving the separation section is cooled and condensed (8), and recovered in the accumulation tank (1), from where it is sent, after under-cooling (2), for re-use in the extraction cycle.

With reference to the “classical” removal cycle, the moving of the solvent takes place by means of a volumetric pump (7) which sucks the liquid leaving the accumulation tank (1) and compresses it at the pressure value of the accumulation tank.

The removal phase is prolonged until the required recovery parameter is reached, referring to the percentage of oily fraction removed with respect to its initial content in the cutting (removal percentage), or the percentage of oily fraction removed referring to the quantity of raw cutting treated (yield percentage).

The time parameter of the removal process is provided by the ratio between the quantity of solvent used with respect to the weight unit of the cutting treated. This weight ratio depends on the process parameters, the type of solvent used, and the type of cutting treated, and ranges from 4 to 30, generally 10.

When the removal phase has been interrupted by the stopping of the continuous flow of solvent, the extractor is isolated and the solvent contained therein is recovered using the auxiliary compressor, necessary in this case for compressing the vapour at the pressure of the accumulation tank.

The recovery phase of the solvent is followed by the final depressurization phase to the atmospheric value and subsequently the recovery of the cutting treated, following the known procedures.

The data referring to a test carried out according to the procedure described above are as follows:

| Solvent fluid | carbon dioxide (CO₂) |
|---|---|
| Type of cutting | conventional |
| Content of inert product | 25% |
| Initial oil content | 9.5% |
| Extraction pressure | 68 bar |
| Extraction temperature | 20° C. |
| Ratio between CO₂ referring to the cutting | 9 kg/kg |
| Final oil content | 1.0% |
| Oil removal degree | >90% |

1. A method for the decontamination of oily cuttings, coming from the drilling of oil wells, and the contemporaneous recovery of the oily component, comprising the following steps:
a. mixing of said cuttings with CO₂ in the liquid state at a pressure value ranging from 45 to 80 bar and a temperature corresponding to the saturation value, with dissolution of the oily fraction of the cutting;
b. removal of the liquid phase (solution) from the solid phase (cutting);
c. expansion and heating of the solution leaving step (b), with the recovery of the oily fraction discharged, and CO₂ in vapour phase;
d. cooling and condensation of the process CO₂ and its recycling to step (a), after possible under-cooling.

2. The method according to claim 1, wherein the mixing of the cuttings takes place at a pressure ranging from 45 to 70 bar, whereas the separation of the oily fraction is effected at a pressure ranging from 30 to 60 bar.

3. The method according to claims 1 and 2, wherein the mixing step of the cuttings and the separation step of the oily fraction take place at a temperature close to the saturation value of the liquid phase.

4. The method according to any of the claims from 1 to 3, wherein the under-cooling degree of the liquid CO₂ ranges from 0 to 5° C.

5. The method according to any of the claims from 1 to 4, wherein the liquid CO₂ is fed to the extraction vessel in a ratio from 2 to 20 times by weight with respect to the cuttings.

6. The method according to any of the claims from 1 to 5, wherein the moving of the liquid CO₂ is effected using a volumetric pump situated between the accumulation tank and the extractor.

7. The method according to any of the previous claims, wherein the oily phase extracted is separated by the use of one or more separators on line.

8. The method according to claim 7, wherein the separation section consists of a single separator with a cyclone effect.

9. The method according to claim 7, wherein the separation section consists of two separators, the first with inertial impact, the second with a cyclone effect.

10. The method according to claims 7-9, wherein a filter for separating the entrained liquid, is situated downstream of the separation section.
